(19) United States
(12) Patent Application Publication
(10) Pub. No.: US 2013/0311524 A1
(43) Pub. Date: Nov. 21, 2013

(54) File Merging System for Merging Layout Input Files

(71) Applicant: SAMSUNG ELECTRONICS CO., LTD., Suwon-si (KR)

(72) Inventors: Chang-Woo Kang, Gwacheon-si (KR); Jae-Pil Shin, Suwon-si (KR); Sang-Won Seo, Bucheon-si (KR); Day-Hyun Jung, Hwaseong-si (KR)

(73) Assignee: SAMSUNG ELECTRONICS CO., LTD., Suwon-si (KR)

(21) Appl. No.: 13/790,999

(22) Filed: Mar. 8, 2013

(30) Foreign Application Priority Data
May 21, 2012 (KR) 10-2012-0053669

(51) Int. Cl. G06F 17/30

(52) U.S. Cl. CPC G06F 17/30079
USPC 707/823

(57) ABSTRACT

A file merging system includes first and second input disks, an output disk, and a processor connected to the first input disk, the second input disk and the output disk. The first input disk includes a first layout input file including a plurality of first cell records. The second input disk includes a second layout input file including a plurality of second cell records. The processor writes the plurality of first cell records and the plurality of second cell records in the output disk without modification.

### CROSS-REFERENCE TO RELATED APPLICATION

This application claims priority under 35 U.S.C. 119 to Korean Patent Application No. 10-2012-0053669, filed on May 21, 2012 in the Korean Intellectual Property Office, the contents of which is herein incorporated by reference in its entirety.

### FIELD OF THE INVENTIVE CONCEPT

The present inventive concept relates to a file merging system, and more particularly to a file merging system for merging layout input files.

### DISCUSSION OF THE RELATED ART

With an increase in the integration density and complexity of semiconductor devices, the structures of mask layouts for fabricating the semiconductor devices are becoming increasingly complex. Therefore, a size of a layout file representing the shape of the mask layout is considerably increased. In order to process the layout files, computing system resources may be heavily taxed. In particular, when the layout file size is larger than a memory size of the computing system, a response time of the computing system is considerably extended.

### SUMMARY

The present inventive concept provides a file merging system having a relatively high processing speed and a relatively low processing load.

The above and other aspects of the present inventive concept will be described in or be apparent from the following description of exemplary embodiments thereof.

According to an aspect of the present inventive concept, there is provided a file merging system including first and second input disks, an output disk, and a processor connected to the first input disk, the second input disk and the output disk. The first input disk includes a first layout input file including a plurality of first cell records. The second input disk includes a second layout input file including a plurality of second cell records.

The processor writes the plurality of first cell records and the plurality of second cell records to the output disk without modification.

According to an aspect of the present inventive concept, there is provided a file merging system. The file merging system includes an input disk in which a layout input file is stored, an output disk in which a layout output file is stored, and a processor connected to the input disk and the output disk. The processor creates the layout output file using the layout input file. A plurality of cell records in the layout input file and a plurality of cell records in the layout output file are placed in the same order.

### BRIEF DESCRIPTION OF THE DRAWINGS

The above and other features and aspects of the present inventive concept will become more apparent by describing in detail exemplary embodiments thereof with reference to the attached drawings in which:

FIG. 1 is a conceptual diagram explaining a processing step of a layout file;

FIG. 2 is a block diagram of a file merging system according to some embodiments of the present inventive concept;

FIG. 3 illustrates an example structure of an OASIS file;

FIG. 4 illustrates an example hierarchical structure of the OASIS file shown in FIG. 3;

FIG. 5 is a diagram of an example layout corresponding to the hierarchical structure shown in FIG. 4;

FIG. 6 is a conceptual diagram illustrating the operation of a file merging system according to some embodiments of the present inventive concept;

FIG. 7 is a conceptual diagram illustrating reference numbers of cells in the layout input files shown in FIG. 6;

FIG. 8 is a conceptual diagram illustrating reference numbers of cells in the layout output file shown in FIG. 6;

FIG. 9 is a conceptual diagram illustrating locations of cells in the layout input files shown in FIG. 6;

FIG. 10 is a conceptual diagram illustrating a hierarchical structure of the layout input files shown in FIG. 6;

FIG. 11 is a conceptual diagram illustrating a hierarchical structure of the layout output file shown in FIGS. 6; and

FIG. 12 is a flowchart illustrating the operation of a file merging system according to some embodiments of the present inventive concept.

### DETAILED DESCRIPTION OF THE EMBODIMENTS

The present invention will now be described more fully hereinafter with reference to the accompanying drawings, in which exemplary embodiments of the invention are shown. This invention may, however, be embodied in different forms and should not be construed as limited to the embodiments set forth herein. Rather, these embodiments are provided so that this disclosure will be thorough and complete, and will fully convey the scope of the embodiments to those skilled in the art. The same reference numbers may indicate the same components throughout the specification. In the attached figures, the thickness of layers and regions may be exaggerated for clarity.

It will also be understood that when a layer is referred to as being “on” another layer or substrate, it can be directly on the other layer or substrate, or intervening layers may also be present.

Spatially relative terms, such as “beneath,” “below,” “lower,” “above,” “upper” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below” or “beneath” other elements or features would then be oriented “above” the other elements or features. Thus, the exemplary term “below” can encompass both an orientation of above and below. The device may be otherwise oriented (rotated 90 degrees or at other orientations) and the spatially relative descriptors used herein interpreted accordingly.

The present invention will be described with reference to perspective views, cross-sectional views, and/or plan views, in which exemplary embodiments of the invention are shown. Thus, the profile of an exemplary view may be modified according to manufacturing techniques and/or allowances. The embodiments of the invention are not intended to limit the scope of the present invention but cover all changes and modifications that can be caused due to a change in manufacturing process. Thus, regions shown in the drawings are illustrated in schematic form and the shapes of the regions are presented simply by way of illustration and not as a limitation.

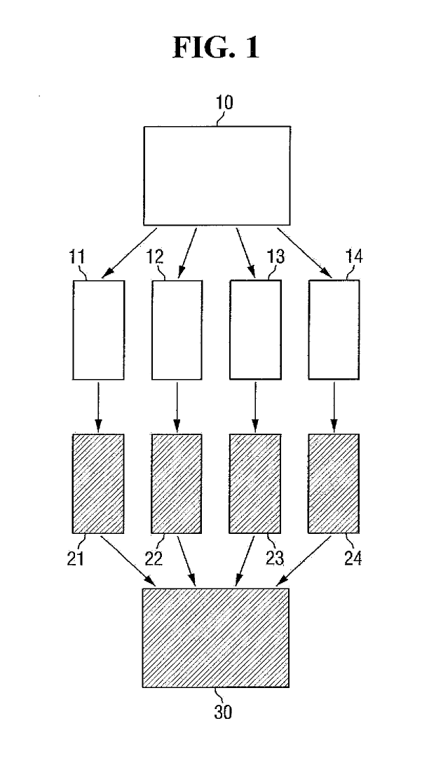

FIG. 1 is a conceptual diagram explaining a processing step of a layout file.

Referring to FIG. 1, modification of a whole layout file 10 may be performed according to the use, purpose or end product. The layout file 10 may be processed by one or more computing system. For example, the whole layout file 10 may have a size of 50 gigabytes to 100 gigabytes. In this case, the whole layout file 10 may be divided into a plurality of partial layout files 11, 12, 13 and 14. The partial layout files 11, 12, 13 and 14 may be processed in a distributed manner by different computing systems. The processed partial layout files 21, 22, 23 and 24 may then be merged into the whole layout file 30.

According to exemplary embodiments, the whole layout file 10 is divided into four partial layout files 11, 12, 13 and 14, but aspects of the present inventive concept are not limited thereto. The whole layout file 10 may be divided into a different number of layout files according to the necessity.

Meanwhile, the processed partial layout files 21, 22, 23 and 24 are merged into the whole layout file 30 by one computing system. Likewise, the partial layout files 21, 22, 23 and 24 may be processed by one or more computing system. A file merging system having a relatively high processing speed and a reduced processing load is described in detail below.

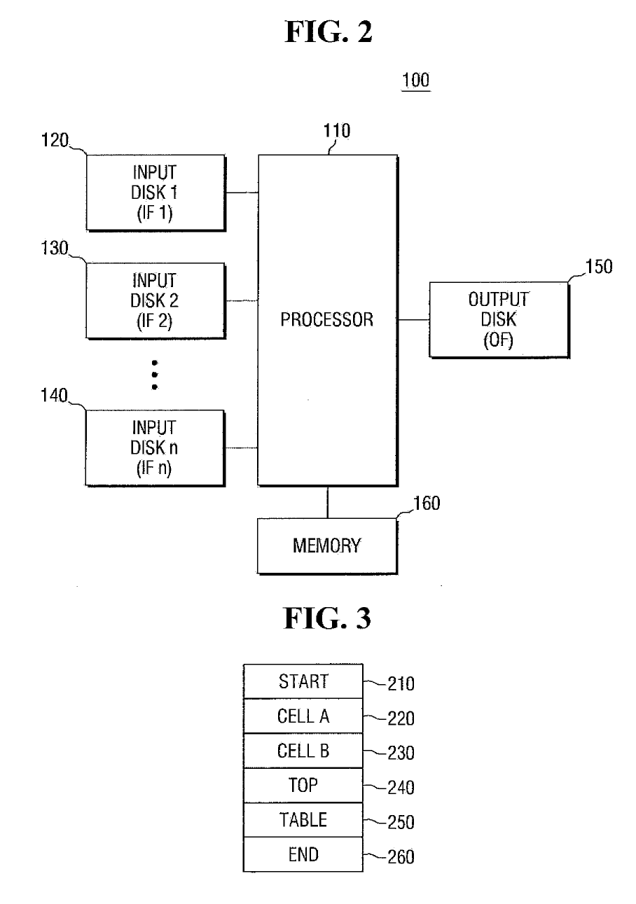

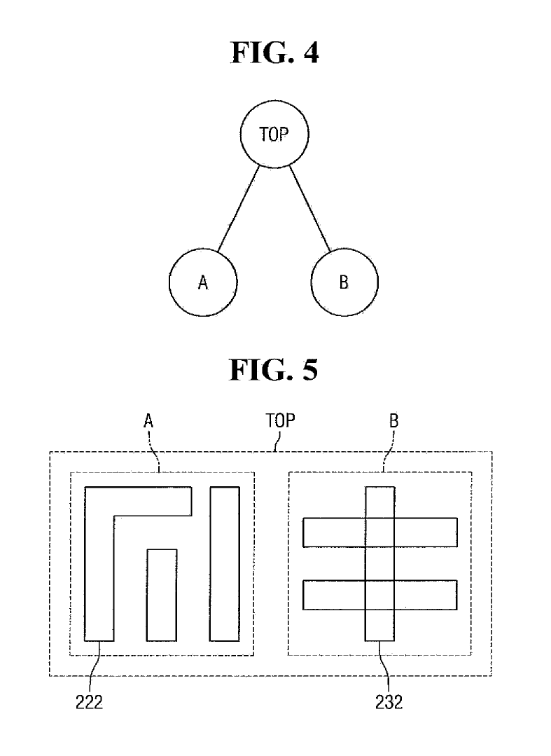

FIG. 2 is a block diagram of a file merging system according to some embodiments of the present inventive concept. FIG. 3 illustrates an example structure of an OASIS (Open Artwork System Interchange Standard) file. FIG. 4 illustrates an example hierarchical structure of the OASIS file shown in FIG. 3. FIG. 5 is a diagram of an example layout corresponding to the hierarchical structure shown in FIG. 4.

First, referring to FIG. 2, the file merging system 100 may include a plurality of input disks 120, 130 and 140, an output disk 150, a processor 110, and a memory 160.

The plurality of input disks 120, 130 and 140 may include layout input files IF1, IF2 and IFn, respectively. Here, the layout input files IF1, IF2 and IFn are partial layout files 21, 22, 23 and 24 of FIG. 1, but aspects of the present inventive concept are not limited thereto.

The output disk 150 stores a layout output file OF created by the processor 110. The layout output file OF may be the whole layout file (30 of FIG. 1), but aspects of the present inventive concept are not limited thereto.

Meanwhile, the layout input files IF1, IF2 and IFn and the layout output file OF may be OASIS files, but aspects of the present inventive concept are not limited thereto. The layout input files IF1, IF2 and IFn and the layout output file OF may be different types of files.

The OASIS will now be briefly described. The OASIS (Open. Artwork System Interchange Standard) is a language used by computers to represent and express an electronic pattern for an integrated circuit during its design and manufacture. The OASIS language defines the code required for geometric shapes such as polygons, rectangles and trapezoids. It defines the type of properties each geometric shape can have, how they can be organized into cells containing patterns made by these shapes and defines how each geometric shape can be placed relative to each other.

Here, the term “Cell” is used to describe a named object in a layout hierarchy.

The term “Placement” is used to describe a specification by reference that a copy of a cell is to be placed within the coordinate space of another cell at a particular location, orientation, and scale.

The term “Geometry” is used to describe a two-dimensional geometric figure such as a polygon, rectangle, trapezoid, etc.

Referring to FIG. 3, the OASIS file may include a plurality of records 210, 220, 230, 240, 250 and 260. The records 210, 220, 230, 240, 250 and 260 may represent principal data divisions in the OASIS file. For example, the records 210, 220, 230, 240, 250 and 260 may include a start record 210, cell records 220 and 230, a top cell record 240, a table record 250, and an end record 260.

The start record 210 identifies the beginning of an OASIS file. For example, the start record 210 may include version information, unit, offsetFlag, offsets, etc.

The end record 260 identifies the end of the OASIS file.

The cell records 220 and 230 may include, for example, cell names, geometric figures (cell shapes), location, placement, annotation information, etc. The geometric figures may include, for example, POLYGON (representing a polygonal figure), RECTANGLE (representing a rectangular figure), TRAPEZOID (representing a trapezoidal figure), CIRCLE (representing a circular figure), etc. The location identifies may represent location of a cell based on a particular origin point. The location may be represented by coordinates on a coordinate plane. Here, both of the cell records 220 and 230 may be represented based on either the same origin point or different origin points.

The top cell record 240 is the record of a cell placed in the topmost level in a hierarchical structure comprised of one or more cell records. The top cell record 240 may include placement of each cell. In addition, the top cell record 240 may also include geometry information that is not included in each cell.

Here, the cell records 220 and 230 and the top cell record 240 will further be described with reference to FIGS. 4 and 5. FIGS. 4 and 5 that illustrate an example hierarchical structure of the OASIS file having a 2-level hierarchy. For example, there may be a cell A and a cell B in a subset of the top cell TOP. As shown in FIG. 5, the cell A may have a geometry 222 and the cell B may have a geometry 232. The top cell TOP may include the cells A and B and may be positioned on the topmost layer of the hierarchy.

While FIGS. 4 and 5 illustrate a 2-level hierarchy, the hierarchical structure may have a 3-level or 4-level hierarchy.

Referring back to FIG. 3, the table record 250 specifies cell names and intrinsic reference numbers matched with the cell names. In addition, the table record 250 may include locations of the cell records 220 and 230 in the file. For example, the cell names cell A, cell B, and cell C may be matched with reference numbers 0, 1, and 2, respectively.

In particular, in describing placement of each cell in the top cell record 240, the placement of each cell may be represented using the reference number corresponding to each cell name. Since the cell name becomes complex and extended, the top cell record 240 can be simplified/accurately represented using the reference number.

Referring back to FIG. 2, the plurality of input disks 120, 130 and 140 may include layout input files IF1, IF2 and IFn, respectively. The respective files IF1, IF2 and IFn may include a plurality of cell records (220 and 230 of FIG. 3).The first layout input file IF1 may include a plurality of first cell records, the second layout input file IF2 may include a plurality of second cell records, and the nth layout input file IFn may include a plurality of nth cell records.

In creating a layout output file (OF), the processor 110 may write the cell records in the layout input files IF1, IF2, and IFn to the output disk 150 without modification. Here, the processor 110 may directly write the cell records in the layout input files IF1, IF2, and IFn to the output disk 150 without loading the records to a memory. Since the cell records are not loaded to the memory, the load of the file merging system 100 performing merge operations can be reduced. In addition, since a time for loading the cell records to the memory is not required, the operating time of the file merging system 100 can be reduced.

After writing the cell records in the layout input files IF1, IF2, and IFn in the output disk 150, the processor 110 may create a new top cell record. If the layout input files IF1, IF2, and IFn are merged, the hierarchical structure comprised of a plurality of cells is modified and a new top cell record having the modified hierarchical structure is required.

After writing the cell records in the layout input files IF1, IF2, and IFn in the output disk 150, the processor 110 may create a new table record. If the layout input files IF1, IF2, and IFn are merged, the reference number may be duplicated. For example, the cell corresponding to the reference number 0 of the first layout input file IF1 may be the cell A, and the cell corresponding to the reference number 0 of the second layout input file IF2 may be the cell C. Here, if the layout input files IF1, IF2, and IFn are merged, there may be two cells, i.e., the cells A and C, corresponding to the reference number 0. Therefore, a new reference number may be created to avoid duplication of reference number. In addition, a new table record having non-duplicated reference number may be used.

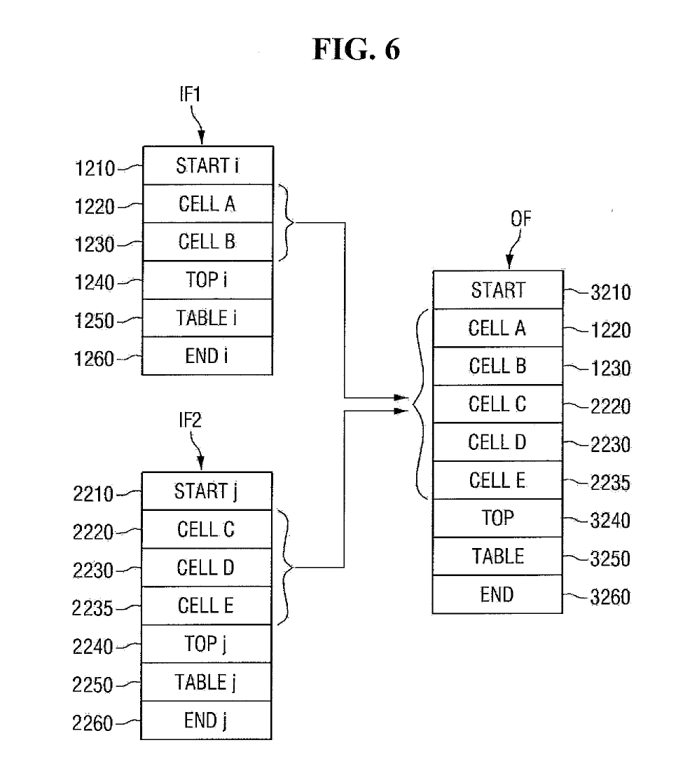

The merging operation of the layout input files IF1, IF2, and IFn will later be described in more detail with reference to FIGS. 6 to 10.

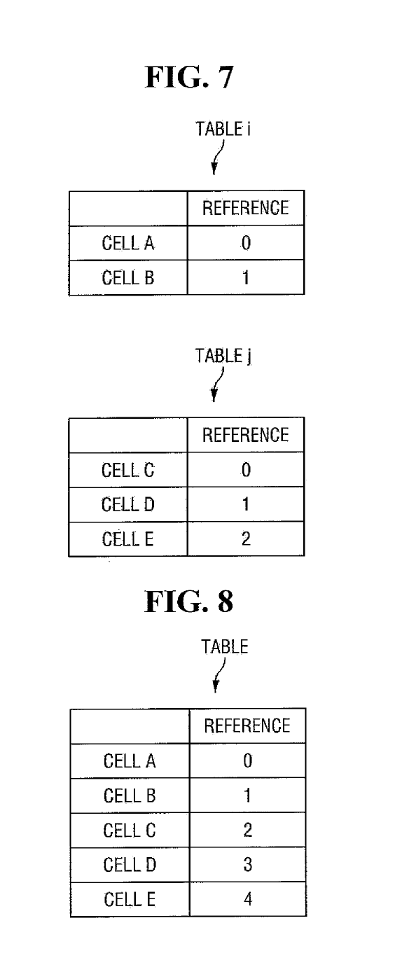

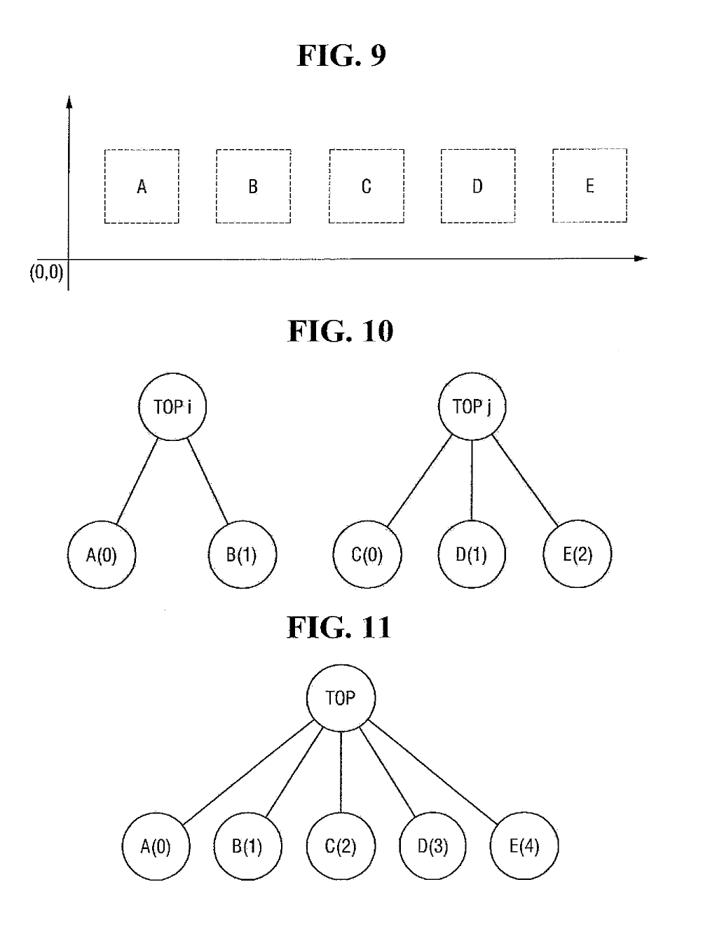

FIG. 6 is a conceptual diagram illustrating the operation of a file merging system according to some embodiments of the present inventive concept. FIG. 7 is a conceptual diagram illustrating reference numbers of cells in the layout input files shown in FIG. 6. FIG. 8 is a conceptual diagram illustrating reference numbers of cells in the layout output file shown in FIG. 6. FIG. 9 is a conceptual diagram illustrating locations of cells in the layout input files shown in FIG. 6. FIG. 10 is a conceptual diagram illustrating a hierarchical structure of the layout input files shown in FIG. 6. FIG. 11 is a conceptual diagram illustrating a hierarchical structure of the layout output file shown in FIG. 6.

Referring to FIG. 6, as described above, the processor (110 of FIG. 2) creates the layout output file OF using the first layout input file IF1 and the second layout input file IF2. The first layout input file IF1 may be stored in the first input disk (120 of FIG. 2), the second layout input file IF2 may be stored in the second input disk (130 of FIG. 2), and the layout output file OF may be stored in the output disk (150 of FIG. 2).

FIG. 6 illustrates, by way of example, that two layout input files IF1 and IF2 are merged, but aspects of the present inventive concept are not limited thereto. Three or more layout input files may also be merged to a single output file.

The first layout input file IF1 may include a start record 1210, a plurality of first cell records 1220 and 1230, a first top cell record 1240, a first table record 1250, and a first end record 1260.

The second layout input file IF2 may include a start record 2210, a plurality of second cell records 2220, 2230 and 2235, a second top cell record 2240, a second table record 2250, and a second end record 2260.

The layout output file OF may include a third start record 3210, a plurality of first cell records 1220 and 1230, a plurality of second cell records 2220, 2230 and 2235, a third top cell record 3240, a third table record 3250, and a third end record 3260.

Here, the processor (110 of FIG. 2) writes the plurality of first cell records 1220 and 1230 and the plurality of second cell records 2220, 2230 and 2235 in the output disk 150 without modification. The processor 110 may write the plurality of first cell records 1220 and 1230 and the plurality of second cell records 2220, 2230 and 2235 in the output disk 150 without loading the same to a memory.

Since the plurality of first cell records 1220 and 1230 and the plurality of second cell records 2220, 2230 and 2235 are written in the layout output file OF in the same manner as described above, the order of the plurality of first cell records 1220 and 1230 stored in the first input disk 120 may be the same as the order of the plurality of first cell records 1220 and 1230 stored in the output disk 150. The plurality of first cell records 1220 and 1230 are stored in the first input disk 120 in the order of the cell A and the cell B, and the plurality of first cell records 1220 and 1230 are also stored in the output disk 150 in the order of the cell A and the cell B. In addition, the order of the plurality of plurality of second cell records 2220, 2230 and 2235 stored in the second input disk 130 may be equal to the order of the plurality of second cell records 2220, 2230 and 2235 stored in the output disk 150. The plurality of first cell records 1220 and 1230 are stored in the second input disk 130 in the order of the cell C, the cell D and the cell E, and the plurality of second cell records 2220, 2230 and 2235 are also stored in the output disk 150 in the order of the cell C, the cell D and the cell E.

The first cell records 1220 and 1230 belonging to the first layout input file IF1 are different from the second cell records 2220, 2230 and 2235 belonging to the second layout input file IF2. As shown, the first layout input file IF1 may include the cell A and the cell B and the second layout input file IF2 may include the cell C, the cell D and the cell E. The cell A need not be equal to any one of the cell C, the cell D and the cell E, and the cell B need not be equal to any one of the cell C, the cell D and cell E.

As described above, if the first cell records 1220 and 1230 are different from the second cell records 2220, 2230 and 2235, the load of creating the layout output file OF can be reduced while increasing the speed of creating the layout output file OF. When the merging is performed, it is not necessary to determine whether the first cell records 1220 and 1230 are the same as the second cell records 2220, 2230 and 2235.

Referring to FIG. 7, a cell name and an intrinsic reference number are matched to the first table record 1250 of the first layout input file IF1. For example, the cell A may be matched to reference number 0, and the cell B may be matched to reference number 1.

A cell name and an intrinsic reference number are matched to the second table record 2250 of the second layout input file IF2. For example, cell C may be matched to reference number 0, the cell D may be matched to reference number 1, and the cell E may be matched to reference number 2.

When the first layout input file IF1 and the second layout input file IF2 are merged into a layout output file OF, a new table record 3250 may be created. As shown in FIG. 7, the reference number of each cell may be duplicated (for example, there may be two cells, i.e., the cells A and C, corresponding to the reference number 0.). Therefore, the processor 110 may compare a cell name with an intrinsic reference number to create a new table record 3250. As shown in FIG. 8, the processor 110 may modify reference number such that the cell C is matched to reference number 2, the cell D is matched to reference number 3 and the cell E is matched to reference number 4.

In addition, as described above, each of the plurality of first cell records 1220 and 1230, and the plurality of second cell records 2220, 2230 and 2235 may include a cell name, a cell shape, a cell location, etc. Here, a location of each of the plurality of first cell records 1220 and 1230 and a location of each of the plurality of second cell records 2220, 2230 and 2235 may be represented based on the same origin point.

For example, as shown in FIG. 9, the cell A and the cell B corresponding to the plurality of first cell records 1220 and 1230 and the cell C, the cell D and the cell E corresponding to the plurality of second cell records 2220, 2230 and 2235 may be represented based on one and the same origin point, e.g., (0, 0) on the coordinate plane.

As described above, when the location of each cell is represented based on one and the same origin point, the location of each of the cell records 1220, 1230, 2220, 2230 and 2235 is not changed even if the first layout input file IF1 and the second layout input file IF2 are merged.

Unlike in FIG. 9, the cell A and the cell B corresponding to the plurality of first cell records 1220 and 1230, and the cell C, the cell D and the cell E corresponding to the plurality of second cell records 2220, 2230 and 2235 may be represented based on different origin points. For example, the cell A and the cell B may be represented based on (0, 0), and the cell C, the cell D and the cell E may be represented based on (10, 0). In this case, the locations of the respective cells A, B, C, D and E may be stored in a programmed manner and the stored locations may then be used when a top cell record is finally created.

The first layout input file IF1 and the second layout input file IF2 may have a 2-level hierarchy. As shown in FIG. 10, the cell A and the cell B may be placed under a top cell TOPi in the first layout input file IF1. Since the first layout input file IF1 has a 2-level hierarchy, no cell is placed under the cell A and the cell B. In addition, the cell C, the cell D and the cell E may be placed under the top cell TOPi in the second layout input file IF2. Since the second layout input file IF2 has a 2-level hierarchy, no cell is placed under the cell C, the cell D and the cell E.

The layout output file OF has a 2-level hierarchy. As shown in FIG. 11, the cell A, the cell B, the cell C, the cell D and the cell E may be placed under the top cell TOP in the layout output file OF. Since the first layout input file IF1 and the second layout input file IF2 are in a 2-level hierarchy, the hierarchical structure of the layout output file OF can be created without difficulty. For example, the hierarchical structure of the layout output file OF can be simply created as the 2-level hierarchy.

As described above, in describing placement of each cell in top cell records TOPi, TOPj and TOP, the placement of each cell is represented using the reference number corresponding to each cell name, rather than using each cell name. Since the cell name becomes complex and extended, representation of the top cell records TOPi, TOPj and TOP can be facilitated. As shown in FIG. 8, the reference number may be modified in the merged layout output file OF and the modified reference number may be used in creating the top cell record TOP.

Consequently, in the file merging system 100 according to some embodiments of the present inventive concept, the processor 110 writes the plurality of first cell records 1220 and 1230 and the plurality of second cell records 2220, 2230 and 2235 in the output disk 150 without modification. The processor 110 may not load the plurality of first cell records 1220 and 1230 and the plurality of second cell records 2220, 2230 and 2235 to the memory. To this end, the plurality of first cell records 1220 and 1230 may be different from the plurality of second cell records 2220, 2230 and 2235. The locations of the first cell records 1220 and 1230 and the locations of the second cell records 2220, 2230 and 2235 may be represented based on the same origin point. The first layout input file IF1, the second layout input file IF2 and the layout output file OF may be in a 2-level hierarchy. Accordingly, the file merging system according to an exemplary embodiment of the present inventive concept may have an increased processing speed while reducing a processing load.

According to an embodiment of the present inventive concept, at least one of the plurality of first cell records 1220 and 1230 and at least one of the plurality of second cell records 2220, 2230 and 2235 may be equal to each other. In this case, the cell record which is the same as the already-written cell record is not written in the layout output file OF. For example, the processor 110 may ignore the same cell record.

According to an embodiment of the present inventive concept, the first layout input file IF1, the second layout input file IF2 and the layout output file OF need not be in a 2-level hierarchy. In this case, time for the processor 110 to compute the hierarchical structure may be allotted.

Meanwhile, as described above, the top cell record may include geometry that is not included in each cell. In this case, the geometry included in the top cell record may be stored in a temporary file or a memory and may then be used when finally creating the top cell record.

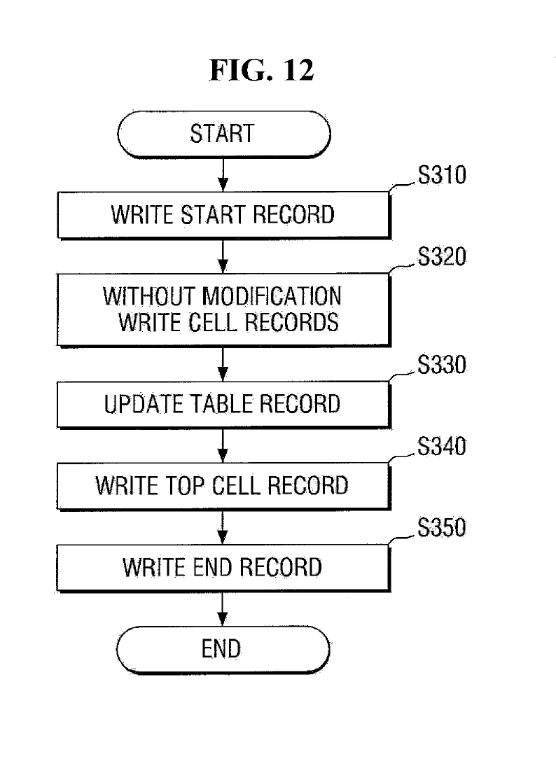

FIG. 12 is a flowchart illustrating the operation of a file merging system according to some embodiments of the present inventive concept, specifically showing an example of the operation described with reference to FIGS. 6 to 11.

Referring to FIG. 12, a start record of a layout input file is identified and then written in the layout output file (S310).

After identifying a plurality of cell records of layout input files, the plurality of cell records are written in the layout output file without modification (S320).

A table record having cell names of the plurality of cell records and reference numbers matched thereto is updated in the layout output file (S330).

A top cell record placed in the topmost layer of a hierarchical structure comprised of the plurality of cell records is created (S340).

After identifying an end record of the layout input file, the end record is written in the layout output file (S350).

While the present inventive concept has been particularly shown and described with reference to exemplary embodiments thereof, it will be understood by those of ordinary skill in the art that various changes in form and details may be made therein without departing from the spirit and scope of the present inventive concept.

What is claimed is:

1. A file merging system comprising:
a first input disk storing a first layout input file therein, the first layout input file including a plurality of first cell records;
a second input disk storing a second layout input file therein, the second layout input file including a plurality of second cell records;
an output disk; and
a processor connected to the first input disk, the second input disk and the output disk, the processor configured to write the plurality of first cell records and the plurality of second cell records to the output disk without modification.

2. The file merging system of claim 1, wherein the processor is configured to write the plurality of first cell records and the plurality of second cell records to the output disk without loading either of the plurality of first cell records or the plurality of second cell records to a memory.

3. The file merging system of claim 1, wherein the first layout input file and the second layout input file are layout input files processed in a distributed manner.

4. The file merging system of claim 1, wherein a sequence of the plurality of first cell records in the first input disk and a sequence of the plurality of first cell records stored in the output disk are identical to each other.

5. The file merging system of claim 1, wherein the plurality of first cell records in the first input disk are different than the plurality of second cell records in the second input disk.

6. The file merging system of claim 1, wherein the first layout input file and the second layout input file have a 2-level hierarchy.

7. The file merging system of claim 1, wherein each of the plurality of first cell record and each of the plurality of second cell record includes a cell name, a cell shape and a cell location.

8. The file merging system of claim 1, wherein a location of each of the plurality of first cell record and a location of each of the plurality of second cell record are represented based on the same origin point

9. The file merging system of claim 1, wherein the first layout input file further includes a first table record connecting a cell name of each of the plurality of first cell records to a corresponding first reference number, and the second layout input file further includes a second table record connecting a cell name of each of the plurality of second cell record to a corresponding second reference number.

10. The file merging system of claim 9, wherein the processor is further configured to create a third table record connecting a cell name of each of the first plurality of cell records and a cell name of each of the plurality of second cell records to new reference numbers after writing each of the plurality of first cell records and each of the plurality of second cell records in the output disk without modification.

11. The file merging system of claim 1, wherein the first layout input file further includes a first top cell record placed at the topmost layer of a hierarchical structure formed by the plurality of first cell records, and the second layout input file further includes a second top cell record placed at the topmost layer of a hierarchical structure formed by the plurality of second cell records.

12. The file merging system of claim 11, wherein the processor is further configured to create a third top cell record placed at the topmost layer of a hierarchical structure formed by the plurality of first cell records and the plurality of second cell records after writing the first plurality of cell records and the second plurality of cell records to the output disk without modification.

13. The file merging system of claim 1, wherein the first layout input file and the second layout input file are OASIS (Open Artwork System Interchange Standard) files.

14. A file merging system comprising:
an input disk storing a layout input file;
an output disk storing a layout output file; and
a processor connected to the input disk and the output disk and configured to create the layout output file using the layout input file,
wherein a plurality of cell records in the layout input file are arranged in an identical order to a plurality of cell records in the layout output file.

15. The file merging system of claim 14, wherein the processor is further configured to write the plurality of cell records in the layout input file in the output disk without modification and to create the layout output file.

16. A method for merging layout input files, comprising:
receiving a first layout input file including a plurality of first cell records from a first input disk;
receiving a second layout input file including a plurality of second cell records from a second input disk; and
writing the plurality of first cell records and the plurality of second cell records to an output disk without modification, using a processor.

17. The method of claim 16, wherein the processor writes the plurality of first cell records and the plurality of second cell records to the output disk without loading either of the plurality of first cell records or the plurality of second cell records to a memory.

18. The method of claim 16, wherein prior to receiving the first and second layout input files, the first layout input files and the second layout input files are each processed in a distributed manner.

19. The method of claim 16, wherein the plurality of first cell records are stored in the output disk in a sequence that is identical to how the plurality of first cell records are stored in the input disk and the plurality of second cell records are stored in the output disk in a sequence that is identical to how the plurality of second cell records are stored in the input disk.

20. The method of claim 16, wherein the first layout input file further includes a first table record connecting a cell name of each of the plurality of first cell records to a corresponding first reference number, and the second layout input file further includes a second table record connecting a cell name of each of the plurality of second cell record to a corresponding second reference number, and
the processor creates a third table record connecting a cell name of each of the first plurality of cell records and a cell name of each of the plurality of second cell records to new reference numbers after writing each of the plurality of first cell records and each of the plurality of second cell records in the output disk without modification.
